(19) United States
(12) Patent Application Publication
(10) Pub. No.: US 2017/0351506 A1
(43) Pub. Date: Dec. 7, 2017

(54) AUTOMATING FEATURE GRADUATION

(71) Applicant: MICROSOFT TECHNOLOGY LICENSING, LLC, Redmond, WA (US)

(72) Inventor: Ilker Celikyilmaz, Redmond, WA (US)

(73) Assignee: MICROSOFT TECHNOLOGY LICENSING, LLC, Redmond, WA (US)

(21) Appl. No.: 15/175,055

(22) Filed: Jun. 7, 2016

(51) Int. Cl. G06F 9/445

(52) U.S. Cl. CPC G06F 8/65

(57) ABSTRACT

A graduation of a feature in an application is automated. A feature deployment service initiates operations to automate feature graduation upon receiving a request to implement a new feature from a developer. The new feature is applied as a new subroutine into an existing class of an application. The existing class includes an old feature related to the new feature. The old feature is also extracted from the existing class for an insertion into an aspect class. The existing class and/or the aspect class are saved into a source code data store. The existing class is also transmitted to the developer for a review.

### BACKGROUND

In today's increasingly networked computing environments, big and versatile hosted services may include multiple applications and have a large number (e.g., thousands) of active features that are in different stages of deployment. New features are usually gradually enabled/introduced to online customers. The process that controls the gradual rollout or deployment is also referred to as “flighting.” Although many features may follow a similar deployment schedule/itinerary, there is no one size fits all approach. This may make it harder to build a flight management system to handle the ever changing requirements, schedules, and itineraries of thousands of features. Conventional deployment systems are managed by developers by checking in a configuration file (e.g., one per environment/ring) to gradually rollout the feature.

Some of the challenges with conventional approaches may include, but are not limited to, lack of gradual rollout protection; lack of real ring validation for flight configurations; unreliable flight train delivery and hot synchronization problems; incremental builds of flights not being able to catch basic errors, leading potentially to costly build breaks; lack of proper/full proof build time validation; developer's need to manage one initial configuration per environment; user making mistakes in generating initial configurations causing high number of problem escalations; and lack of control of how fast a feature is deployed to environments.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to automated feature graduation. A feature deployment service, according to embodiments, may initiate operations to automate feature graduation upon receiving a request from a developer to implement a new feature of an application. Next, the new feature is applied as a new subroutine into an existing class of the application. The existing class includes an old feature related to the new feature. Furthermore, the old feature of the application may be extracted from the existing class for an insertion into an aspect class. The existing and the aspect classes may be saved into a source code data store. The existing class may also be transmitted to the developer for review.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of automating a feature graduation in an application, according to embodiments;

FIG. 2 is a display diagram illustrating example components of a feature deployment service that automates a feature graduation in an application, according to embodiments;

FIG. 3 is a display diagram illustrating a scheme to automate a feature graduation in an application, according to embodiments;

FIG. 4 is a display diagram illustrating an example flow of actions between stakeholders of a scheme to automate a feature graduation in an application, according to embodiments;

FIG. 5 is a simplified networked environment, where a system according to embodiments may be implemented;

FIG. 6 is a block diagram of an example computing device, which may be used to automate a feature graduation in an application, according to embodiments; and

FIG. 7 is a logic flow diagram illustrating a process to automate a feature graduation in an application, according to embodiments.

### DETAILED DESCRIPTION

As briefly described above, a feature graduation may be automated in an application by a feature deployment service. In an example scenario, the feature deployment service may receive a request to implement a new feature of an application. The request may include a source code snippet or instructions to insert a new subroutine (also known as a function and/or a method of a class of source code) into an existing class of the application. In response, the new feature may be applied as a new subroutine into an existing class of the application. The existing class may include an old feature related to the new feature.

The old feature of the application may be extracted from the existing class for an insertion into an aspect class. The aspect class may include an abstract class that may be provided during an implementation of the application unless the old feature is graduated (or decommissioned). The existing class and the aspect class may be saved into a source code data store. The source code data store may host the source code for the application, which may be updated with the existing class and the aspect class. The existing and/or the aspect classes may be executed at a runtime during an implementation of the application. Furthermore, the existing class may be transmitted to the developer for a review.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to automate a feature graduation in an application. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

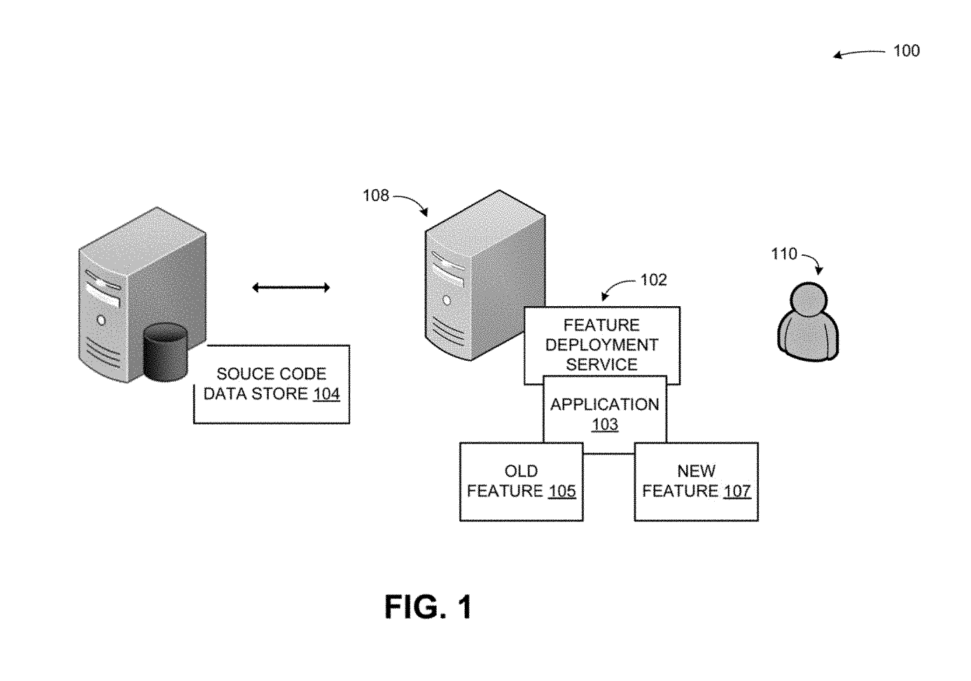

FIG. 1 is a conceptual diagram illustrating examples of automating a feature graduation in an application, according to embodiments.

In a diagram 100, a computing device 108 may execute a feature deployment service 102. The computing device 108 may include a desktop computer, a mobile computer, and/or a physical server that provide service(s) and/or application(s). A service may include an application performing operations in relation to a client application and/or a subscriber, among others.

The computing device 108 may execute the feature deployment service 102. The feature deployment service 102 may initiate operations to automate a feature graduation in an application 103 upon receiving a request from a developer 110 to implement a new feature 107 of the application 103. In the example configuration of FIG. 1, the developer may include a programmer, an engineer, a stakeholder, among other entities who may be allowed to create, alter, and/or manage a source code of the application 103. The application 103 may include a client application, a local application, a distributed application, and/or a mobile application, among others. The new feature may include a source code snippet and/or instruction(s) to create a new subroutine (also known as a function and/or a method) of a class of the application 103. A class may include a self-contained unit of the application that provides function(s) that may be associated with a purpose of the class. An example may include a streaming class that provides input and output functions to import and export data, among others.

In response to the request to implement the new feature 107, the feature deployment service may apply the new feature as a subroutine into an existing class of the application 103. The existing class may also include an old feature 105 related to the new feature 107. The old feature 105 and the new feature 107 may be related based on a common attribute. The new feature 107 may be an updated version of the old feature 105, among other relationships.

The feature deployment service 102 may extract the old feature 105 from a source code of the existing class of the application for an insertion into an aspect class. An aspect class may include a class structured with placeholder(s) to self-alter a source code of the aspect class on the fly. An example may include replacing a subroutine within the aspect class with new or updated subroutine through subroutine calls made to the aspect class. The aspect class may also include an abstract class. The abstract class may include a base class that may not be instantiated but may contain an abstract method and/or accessor. The aspect class may include a type of abstract class such as a feature abstract class.

The existing class and the aspect class may be saved into a source code data store 104. The source code data store may host a source code of the application 103 that may include the existing class and the aspect class. The source code of the application 103 may be used to implement the application 103 during an execution of the application 103 at a runtime. Furthermore, the existing class may be transmitted to the developer for a review.

The computing device 108 may communicate with the source code data store 104 through a network. The network may provide wired or wireless communications between nodes such as the source code data store 104, or the computing device 108, among others. Previous example(s) to automate a feature graduation in an application are not provided in a limiting sense. Alternatively, the feature deployment service 102 may manage the application 103 at a desktop application, a workstation application, and/or a server application, among others. The feature deployment service 102 may also provide a client interface for rendering.

The developer 110 may interact with a client interface of the feature deployment service 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 108, the feature deployment service 102, embodiments are not limited to these components or system configurations and can be implemented with other system configuration employing fewer or additional components.

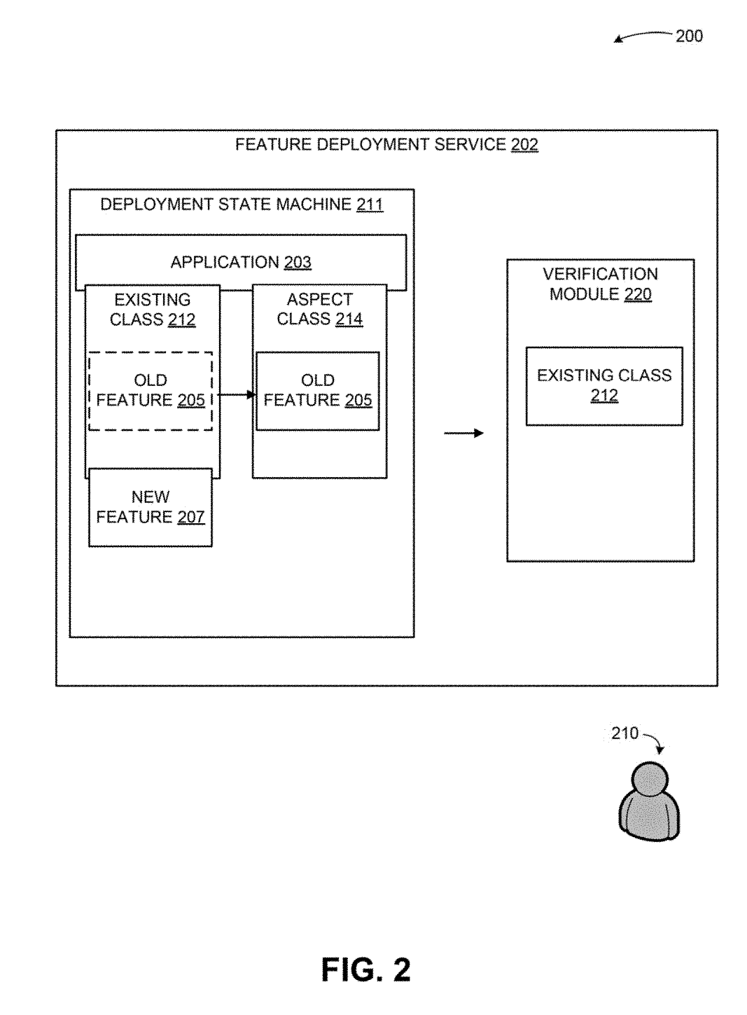

FIG. 2 is a display diagram illustrating example components of a feature deployment service that automates a feature graduation in an application, according to embodiments.

In a diagram 200, a deployment state machine 211 of a feature deployment service 202 may receive a request to insert a new feature 207 into an application 203. The new feature 207 may include a source code snippet that expresses functionality. The new feature 207 may include an update for an old feature 205 of the existing class 212. The update may modify a functionality provided by the old feature 205. The old feature may also be implemented as a subroutine and/or another source code structure to express functionality within the existing class 212. The existing class may include the old feature 205, which may be related to the new feature 207. The developer 210 may define the relationship between the new feature 207 and the old feature 205. Alternatively, the relationship may be automatically identified by comparing the source code of the new feature 207 and the old feature 205 to detect a common attribute (such as a title, common code, and/or input/output parameters, among others).

Next, the deployment state machine 211 may create an aspect class 214 to store the old feature 205. The aspect class 214 may include a placeholder to insert source code into the aspect class through a subroutine call to the aspect class. The aspect class may be an abstract class that may serve as a base class to instantiate other classes. Furthermore, the old feature 205 may be extracted from the existing class 212 and inserted into the aspect class 214. Prior to an activation of the new feature 207, the old feature 205 may be executed during an implementation (also known as a flow, and/or an execution path) of the application 203 by providing the old feature 205 through the aspect class 214. However, after an instruction to activate the new feature 207 (from the developer 210), the aspect class 214 may be automatically deleted. As such, the old feature 205 may be removed from an implementation of the application 203.

A verification module 220 of the feature deployment service 202 may transmit the existing class 212 to the developer 210 for a review. The existing class 212 may be transmitted to the developer 210 after an insertion of the new feature 207 into the existing class 212 as a new subroutine. The developer 210 may provide a feedback associated with a success of the insertion of the new feature 207 into the existing class 212 as a new subroutine. The feedback may be analyzed to identify operation(s) to modify/customize the new subroutine to comply with a request by the developer 210 to change (or customize) the new feature 207. The operation(s) may be executed to modify/customize the existing class to implement the new feature 207 based on the request(s) by the developer 210.

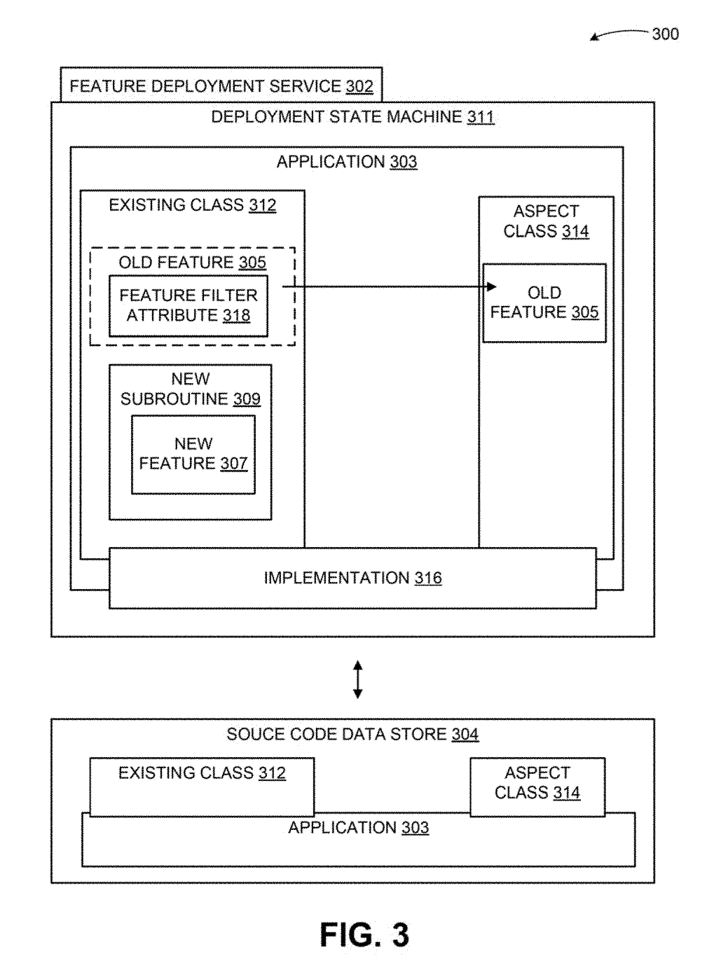

FIG. 3 is a display diagram illustrating a scheme to automate a feature graduation in an application, according to embodiments.

In a diagram 300, a feature deployment service 302 may execute a deployment state machine 311 that may manage a source code for an application 303. In response to a request from a developer, a new feature 307 may be inserted into an existing class 312 of the application 303 as a new subroutine 309 to replace an old feature 305. The old feature 305 of the existing class 312 may be extracted into a newly created aspect class 314. The old feature 305 may also include a feature filter attribute 318. The feature filter attribute 318 may include a feature name, a class name, and/or a subroutine name, among others. The old feature 305 may be called with the feature filter attribute 318 to extract the old feature 305 from the existing class 312 for an insertion into the aspect class 314. As such, the old feature 305 may still be provided as a function of the application 303 through the aspect class 314. The aspect class 314 may be provided at an implementation 316 (a runtime execution path and/or a flow) of the application 303 (until an activation of the new feature 307). The existing class 312 and the aspect class 314 may be stored at a source code data store 304 that may host a source code of the application 303 that may be compiled and executed at an implementation 316 of the application 303.

In an example scenario, the deployment state machine 311 may receive an activation request from the developer to activate the new feature 307. In response, the new feature 307 may be activated by referencing the new subroutine 309 of the existing class 312 at an implementation 316 of the application 303. The implementation 316 may include a flow of the application 303, which may also be referred as an execution path. When activated, the new feature 307 may be provided through a call submitted to the new subroutine 309.

While activating the new feature 307, the deployment state machine 311 may also graduate (or decommission) the old feature 305. In an example, the old feature 305 may be graduated upon receiving a graduation request from the developer. The old feature 305 may also be graduated upon activation of the new feature. The old feature 305 may be deactivated by dereferencing the aspect class 314 at the implementation 316 of the application 303. Alternatively, the old feature may be deactivated by removing the aspect class 314 from a source code data store that hosts the source code of the application 303.

If the developer has not activated the new feature 307 and has kept the new feature 307 deactivated, the deployment state machine 311 may provide the aspect class 314 for an execution of the old feature 305 at the implementation 316 of the application 303. As a result, a return value that includes a product of the execution of the old feature is provided to an entity that executes the application 303 and calls the old feature 305. The return value may include a dataset, among other things.

Alternatively, if the developer has activated the new feature 307, the existing class 312 may be provided for an execution of the new feature 307 at the implementation 316 of the application 303. As a result, a return value that includes a product of the execution of the new feature 307 is provided to an entity that executes the application 303 and calls the new feature 307. The return value may include a dataset, among other things.

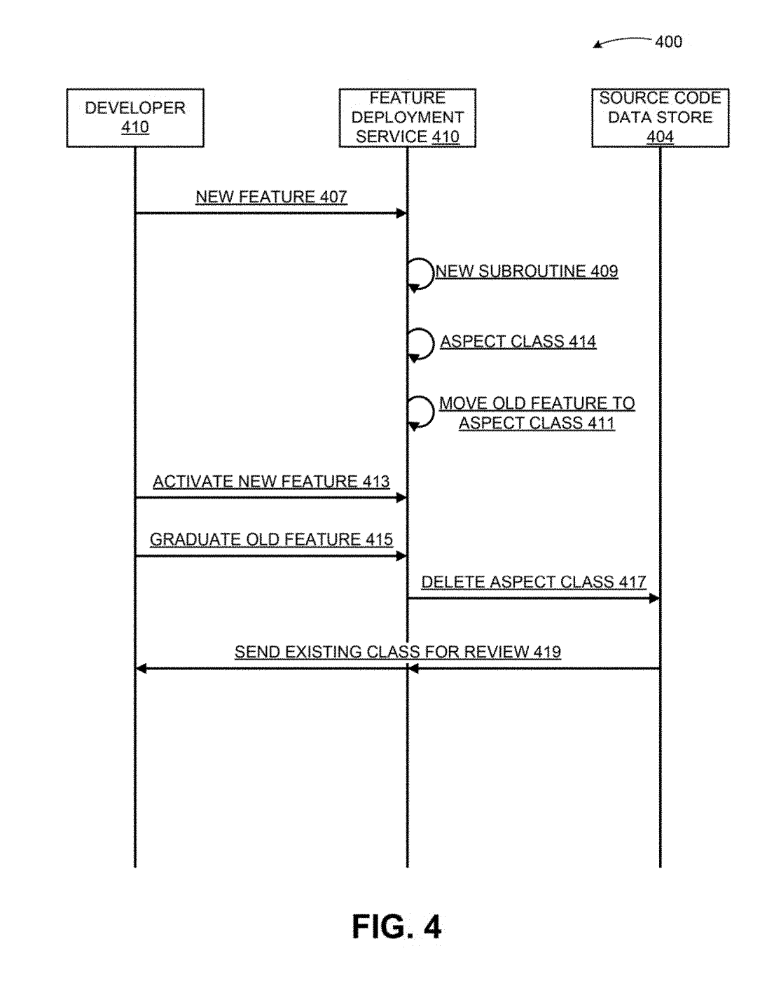

FIG. 4 is a display diagram illustrating an example flow of actions between stakeholders of a scheme to automate a feature graduation in an application, according to embodiments.

In a diagram 400, a feature deployment service 402 automates a feature graduation. In an example scenario, a request for a new feature 407 may be received from a developer 410. In response, a new subroutine 409 may be inserted into an existing class of an application. The new subroutine 409 may include the new feature 407. An aspect class 414 may be created to store an old feature related to the new feature 407. Next, the feature deployment service 402 may execute an operation to move the old feature (from the existing class) to the aspect class 411. The aspect class 414 may provide the old feature to an implementation of the application until an activation of the new feature and a graduation of the old feature. The aspect class 414 and the existing class may be stored in a source code data store 404 to provide a source code of the application for an implementation of the application at a runtime.

In a next action, a request to activate new feature 413 may be received from the developer. In response, the new feature 407 may be activated. In an example scenario, upon activation of the new feature 407, the old feature may be graduated by removing the aspect class 414. The aspect class 414 is removed by dereferencing the aspect class 414 and/or by deleting the aspect class 414 from the source code data store 404. Alternatively, an automated operation to delete an aspect class 417 may be executed upon receiving a request to graduate the old feature 415. The feature deployment service 402 may transmit a request to delete the aspect class 417 (to the source code data store 404) to prompt the source code data store 404 to remove the aspect class 414. Upon deletion of the aspect class 414, the old feature may no longer be available for execution at a runtime during an implementation of the application. Upon graduating the old feature, the feature deployment service 402 may retrieve the existing class from the source code data store 404. An operation to send the existing class for review 419 may be executed to prompt the developer 410 to review an integration of the new feature into the existing class. Alternatively, the source code data store 404 may also be instructed to move a source code of the old feature into an archive storage to maintain the old feature for a potential future retrieval upon receiving a request to graduate the old feature (or a request to activate the new feature).

In an example scenario, the feature deployment service 402 may modify the existing class with an aspect oriented scheme to insert the new subroutine into a joint location associated with the old feature. Furthermore, the existing class may be altered with the aspect oriented scheme to extract subroutine(s) associated with the old feature for insertion into the aspect class 414.

Furthermore, a feature filter attribute may be provided to the existing class to activate the new feature 407. The feature filter attribute may include a feature name, a class name, and/or a subroutine name, among others. The new subroutine 409 may also be encapsulated within an object array.

A relationship between the new feature 407 and the old feature may be established upon receiving a selection from the developer that relates the new feature 407 to the old feature. Alternatively, the relationship may be established automatically by matching an attribute (such as a name, a title, a input/output value, and/or common code, among others) of the new feature to another attribute of the old feature. The new feature and the old feature may be related based on the matched attribute.

Automating a graduation of the old feature may be illustrated with an example scenario such as:

```
public class ActivateFeatureAspects : MethodLevelAspect, IAspectProvider
{
  private static readonly List<IAspect> featureAspects =
  new List<IAspect>( );
  private: const string FEATURE _INTERFACE =
  “AspectOrientedPrj.Aspects.IFeature”;
  static ActivateFeatureAspects( )
  {
    Assembly[ ] assemblies =
    AppDomain.CurrentDomain.GetAssemblies( );
    foreach (var assembly in assemblies)
      foreach (var type in assembly.GetTypes( ))
      {
        if (type.IsClass &&
          !type.IsAbstract &&
          type.GetInterface(FEATURE_INTERFACE) ! = null)
        {
          IAspect featureAspect = Activator.CreateInstance(type)
          as IAspect;
          Message.Write(MessageLocation.Of
(MessageLocation.Explicit(“ActivateFeatureAspects”)),
            SeverityType.ImportantInfo, “FEI1000”, “Aspect {0}
has been applied.”, featureAspect.GetType( ).FullName);
          featureAspects.Add(featureAspect);
        }
      }
  }
  public IEnumerable<AspectInstance> ProvideAspects(object
  targetElement)
  {
    foreach (var aspect in featureAspects)
      yield return new AspectInstance(targetElement, aspect);
  }
}
```

The new feature may be provided in an implementation of the application if activated. Alternatively, the old feature may be provided in the implementation of the application if the new feature is not activated. An example scenario may include:

```
public override void OnEntry(MethodExecutionArgs args)
    {
      if (!isFeatureEnabled( ))
      {
        args.ReturnValue = PreviousFlow(args.Arguments.ToArray( ));
        args.FlowBehavior = FlowBehavior.Return;
      }
    }
    /// <summary>
    /// This subroutine provides the new feature which should include the
    /// old feature when the new feature is not activated.
    /// </summary>
    /// <param name=“args”></param>
    /// <returns>If there is any return value. If the implementation doesn't
return any value, then return null</returns>
    internal abstract object PreviousFlow(object[ ] args);
        An example of the new feature within a new subroutine
        may include:
public void DoSomething(string text, int i)
    {
      Console.WriteLine(string.Format(“MyImplementation.DoSomething
execution using ‘{0}’ and {1}”, text, i));
      // Old Feature/code
      //Console.ForegroundColor = ConsoleColor.Blue;
      //Console.WriteLine(“Blue Button is displayed, {0}” text);
      // New Feature code
      ConsoleColor consoleColor = ImplementFeatureRedText(text);
      Console.WriteLine(“Text color is ” + consoleColor);
}
private ConsoleColor ImplementFeatureRedText(string text)
{
    Console.ForegroundColor = ConsoleColor.Red;
    Console.WriteLine(“Red Text is Displayed, {0}”, text);
    return ConsoleColor.Red;
}
```

An example of the old implementation (also referred to as a flow or execution path) inserted into the aspect class may include:

```
[FeatureFilter(“Red Text Feature”, “AspectOrientedPrj.
MyImplementation”, “ImplementFeatureRedText”)]
[Serializable]
  public sealed class OldFeatureBlueText : Feature
  {
    /// <summary>
    /// This subroutine provicdes the text in Blue color.
    /// </summary>
    /// <param name=“args”>Zero index argument
    is the text to be printed<param>
    /// <returns>Blue ConsoleColor</return>
    internal sealed override object PreviousFlow(object[ ] args)
    {
      string text = (string)args[0];
      Console.ForegroundColor = ConsoleColor.Blue;
      Console.WriteLine(“Blue Text is displayed, {0}”, text);
      return Console.ForegroundColor;
  }
}
```

An example of the existing class with the new subroutine (that includes the new feature) compiled at an implementation of the application (at runtime) may include:

```
private ConsoleColor ImplementFeatureRedText(string text)
{
      MethodExecutionArgs methodExecutionArgs =
new MethodExecutionArgs(null, new Arguments<string>
      {
        Arg0 = text
      });
      <>z_a_1.a71.OnEntry(methodExecutionArgs);
      ConsoleColor result;
      if (methodExecutionArgs.FlowBehavior ==
      FlowBehavior.Return)
      {
        result = (ConsoleColor)
        methodExecutionArgs.ReturnValue;
      }
      else
      {
        // New Feature
        Console.ForegroundColor = ConsoleColor.Red;
        Console.WriteLine(“Red Button is Displayed, {0}”, text);
        ConsoleColor consoleColor = ConsoleColor.Red;
        result = consoleColor;
      }
      return result;
      }
    }
-----------
public override void OnEntry(MethodExecutionArgs args)
{
    bool flag = !this.isFeatureEnabled( );
  if (flag)
  {
    args.ReturnValue = this.Previous(args.Arguments.ToArray( ));
    args.FlowBehavior = FlowBehavior.Return;
  }
}
```

As discussed above, the feature deployment service may be employed to perform operations to automate a feature graduation in an application. An increased user efficiency with the feature deployment service 102 may occur as a result of inserting a new feature as a new subroutine into an existing class of an application while extracting the old feature for an insertion into an aspect class for continued use until activation of the new feature (or graduation of the old feature). Additionally, graduation of the old feature by removing the aspect class by the feature deployment service 102, may reduce processor load, increase processing speed, conserve memory, and reduce network bandwidth usage.

Embodiments, as described herein, address a need that arises from a lack of efficiency to automate a feature graduation in an application. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Automating a feature graduation in an application may be implemented in configurations employing fewer or additional components in applications and user interfaces. Furthermore, the example schema and components shown in FIG. 1 through 4 and their subcomponents may be implemented in a similar manner with other values using the principles described herein.

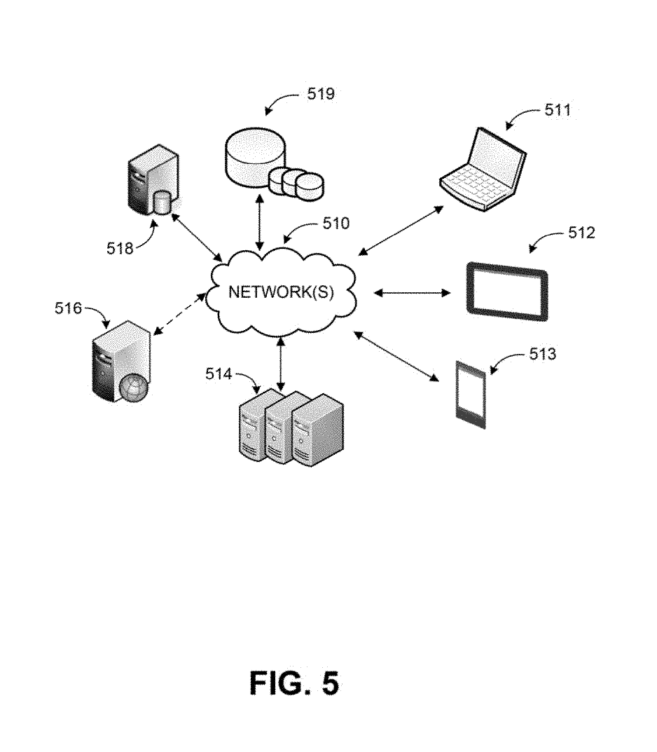

FIG. 5 is an example networked environment, where embodiments may be implemented. A feature deployment service configured to automate a feature graduation in an application may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A feature deployment service may apply a new feature as a new subroutine into an existing class of an application upon receiving a request by a developer. The existing class may include an old feature related to the new feature. The old feature may be extracted from the existing application for an insertion into an aspect class. The existing class and the aspect class may be saved into a source code data store. Furthermore, the existing class may be transmitted to the developer for a review. The feature deployment service may store data associated with the existing class and the aspect class in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to automate a feature graduation in an application. Furthermore, the networked environments discussed in FIG. 5 are for illustration purposes only. Embodiments are not limited to the example applications, modules, or processes.

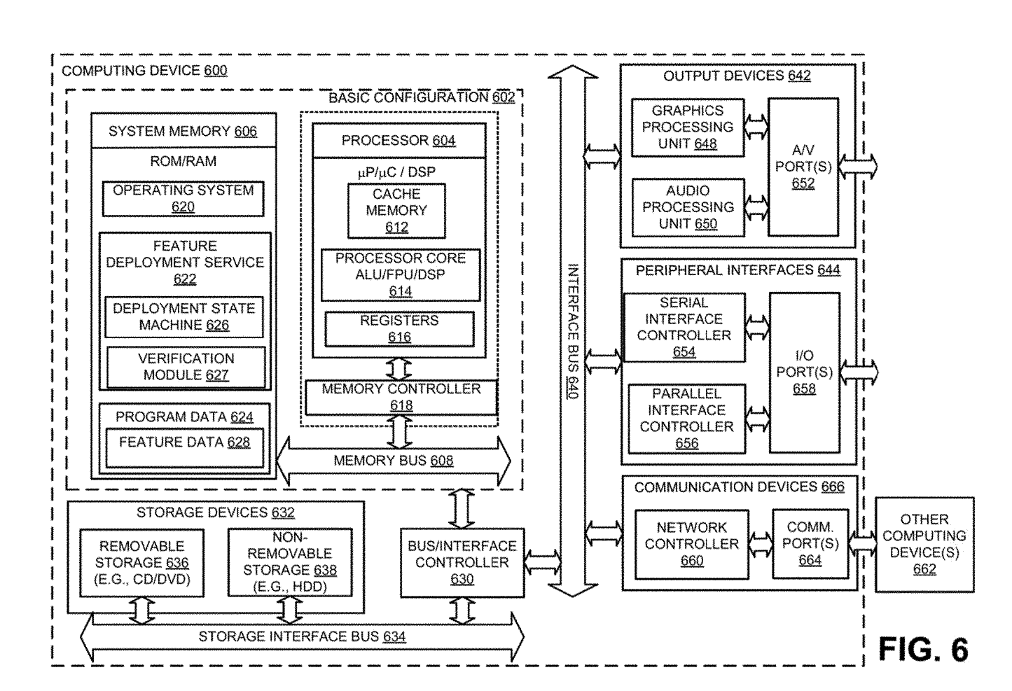

FIG. 6 is a block diagram of an example computing device, which may be used to automate a feature graduation in an application, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a feature deployment service 622, and a program data 624. The feature deployment service 622 may include components such as a deployment state machine 626 and a verification module 627. The deployment state machine 626 and the verification module 627 may execute the processes associated with the feature deployment service 622. The deployment state machine 626 may apply a new feature as a new subroutine into an existing class of an application upon receiving a request by a developer. The existing class may include an old feature related to the new feature. The old feature may be extracted from the existing application for an insertion into an aspect class. The existing class and the aspect class may be saved into a source code data store. The verification module 627 may transmit the existing class to the developer for a review.

Input to and output out of the feature deployment service 622 may be transmitted through a communication device associated with the computing device 600. An example of the communication device may include a networking device that may be communicatively coupled to the computing device 600. The networking device may provide wired and/or wireless communication. The program data 624 may also include, among other data, feature data 628, or the like, as described herein. The feature data 628 may include a source code for the new feature and/or the old feature, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus (40 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to automate a feature graduation in an application. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

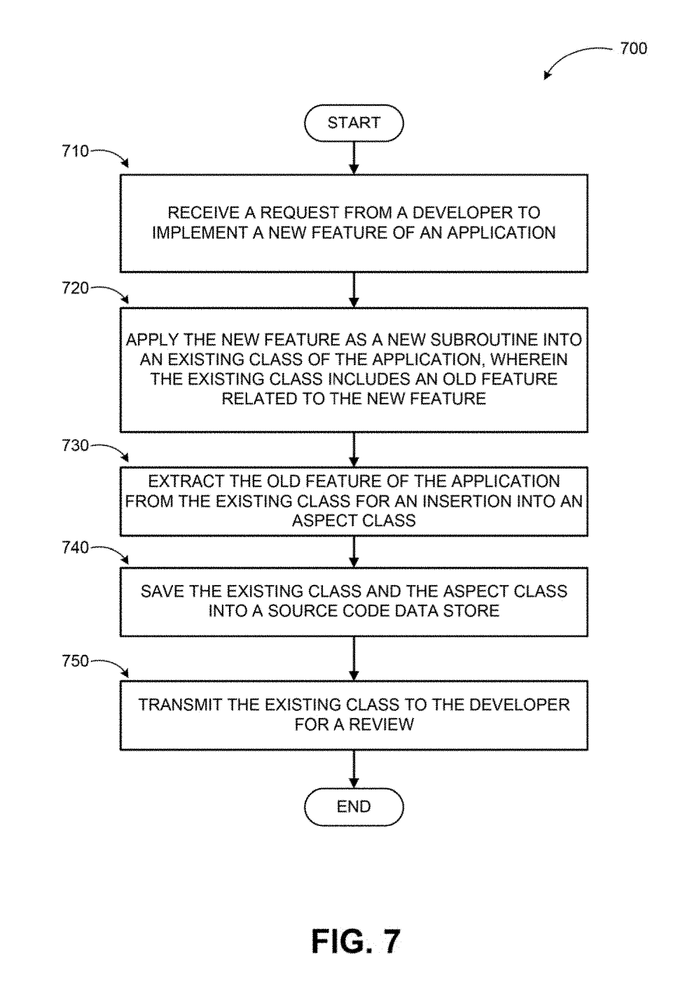

FIG. 7 is a logic flow diagram illustrating a process to automate a feature graduation in an application, according to embodiments. Process 700 may be implemented on a computing device, such as the computing device 600 or another system.

Process 700 begins with operation 710, where the feature deployment service receives a request from a developer to implement a new feature of an application. Next, at operation 720, the new feature may be applied as a new subroutine into an existing class of the application. The existing class may include an old feature related to the new feature.

At operation 730, the old feature of the application may be extracted from the existing class for an insertion into an aspect class. The old feature may be inserted into the aspect class to provide the old feature through the aspect class until an activation of the new feature. At operation 740, the existing class and the aspect class may be saved into a source code data store. The source code data store may provide a source code of the application during an implementation of the application at a runtime of the existing class and/or the aspect class. At operation 750, the existing class may be transmitted to the developer for a review.

The operations included in process 700 are for illustration purposes. Automating a feature graduation in an application may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a computing device to automate a feature graduation is described. The computing device includes a communication device, a memory configured to store instructions associated with a feature deployment service, processor(s) coupled to the memory and the communication device. The processor(s) execute the feature deployment service in conjunction with the instructions stored in the memory. The feature deployment service includes a deployment state machine and a verification module. The deployment state machine is configured to receive a request from a developer to implement a new feature of an application, apply the new feature as a new subroutine into an existing class of the application, where the existing class includes an old feature related to the new feature, extract the old feature of the application from the existing class for an insertion into an aspect class, and save the existing class and the aspect class into a source code data store. The verification module is configured to transmit, through the communication device, the existing class to the developer for a review.

In other examples, the deployment state machine is further configured to receive an activation request from the developer to activate the new feature, activate the new feature of the application by referencing the new subroutine of the existing class at an implementation of the application, receive a graduation request from the developer to graduate the old feature, deactivate the old feature of the application by dereferencing the aspect class at the implementation of the application, and remove the aspect class from the source code data store. The aspect class includes a feature abstract class. A feature filter attribute of the old feature includes a feature name, a class name, and a subroutine name. An argument for the new subroutine is encapsulated within an object array

In further examples, the deployment state machine is further configured to in response to a deactivation of the new feature, provide the aspect class for an execution of the old feature at an implementation of the application and send a return value that includes a product of the execution of the old feature. The deployment state machine is further configured to in response to an activation of the new feature, provide the existing class for an execution of the new feature at an implementation of the application and send a return value that includes a product of the execution of the new feature.

In some examples, a method executed on a computing device to automate a feature graduation is described. The method includes receiving a request from a developer to implement a new feature of an application, applying the new feature as a new subroutine into an existing class of the application, where the existing class includes an old feature related to the new feature, extracting the old feature of the application from the existing class for an insertion into an aspect class, saving the existing class and the aspect class into a source code data store, receiving an activation request from the developer to activate the new feature, removing the aspect class from the source code data store, and transmitting the existing class to the developer for review.

In other examples, the method further includes modifying the existing class with an aspect oriented scheme to insert the new subroutine into a joint location associated with the old feature. The method further includes altering the existing class with an aspect oriented scheme to extract one or more subroutines associated with the old feature for the insertion into the aspect class. The method further includes providing a feature filter attribute to the existing class to activate the new feature, where the feature filter attribute includes a feature name, a class name, and a subroutine name. The method further includes receiving a selection from the developer that relates the new feature to the old feature. The method further includes matching an attribute of the new feature to another attribute of the old feature and relating the new feature to the old feature based on the matched attribute.

In some examples, a computer-readable memory device with instructions stored thereon to automate a feature graduation is described. The instructions include actions that are similar to the actions of the method.

In some example, a means for automating a feature graduation is described. The means for automating the feature graduation includes a means for receiving a request from a developer to implement a new feature of an application, applying the new feature as a new subroutine into an existing class of the application, where the existing class includes an old feature related to the new feature, extracting the old feature of the application from the existing class for an insertion into an aspect class, saving the existing class and the aspect class into a source code data store, and transmitting the existing class to the developer for a review.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A computing device to automate a feature graduation, the computing device comprising:
a communication device;
a memory configured to store instructions associated with a feature deployment service;
one or more processors coupled to the memory and the communication device, the one or more processors executing the feature deployment service in conjunction with the instructions stored in the memory, wherein the feature deployment service includes:
a deployment state machine configured to:
receive a request from a developer to implement a new feature of an application;
apply the new feature as a new subroutine into an existing class of the application by modifying the existing class with an aspect oriented scheme to insert the new subroutine into a joint location associated with an old feature, wherein the existing class includes the old feature related to the new feature;
extract the old feature of the application from the existing class for an insertion into an aspect class;
save the existing class and the aspect class into a source code data store; and
a verification module configured to:
transmit, through the communication device, the existing class to the developer for a review.

2. The computing device of claim 1, wherein the deployment state machine is further configured to:
receive an activation request from the developer to activate the new feature; and
activate the new feature of the application by referencing the new subroutine of the existing class at an implementation of the application.

3. The computing device of claim 2, wherein the deployment state machine is further configured to:
receive a graduation request from the developer to graduate the old feature; and
deactivate the old feature of the application by dereferencing the aspect class at the implementation of the application.

4. The computing device of claim 3, wherein the deployment state machine is further configured to:
remove the aspect class from the source code data store.

5. The computing device of claim 1, wherein the aspect class includes a feature abstract class.

6. The computing device of claim 1, wherein a feature filter attribute of the old feature includes a feature name, a class name, and a subroutine name.

7. The computing device of claim 1, wherein an argument for the new subroutine is encapsulated within an object array.

8. The computing device of claim 1, wherein the deployment state machine is further configured to:
in response to a deactivation of the new feature,
provide the aspect class for an execution of the old feature at an implementation of the application.

9. The computing device of claim 8, wherein the deployment state machine is further configured to:
send a return value that includes a product of the execution of the old feature.

10. The computing device of claim 1, wherein the deployment state machine is further configured to:
in response to an activation of the new feature,
provide the existing class for an execution of the new feature at an implementation of the application.

11. The computing device of claim 10, wherein the deployment state machine is further configured to:
send a return value that includes a product of the execution of the new feature.

12. A method executed on a computing device to automate a feature graduation, the method comprising:
receiving a request from a developer to implement a new feature of an application;
applying the new feature as a new subroutine into an existing class of the application by modifying the existing class with an aspect oriented scheme to insert the new subroutine into a joint location associated with an old feature, wherein the existing class includes the old feature related to the new feature;
extracting the old feature of the application from the existing class for an insertion into an aspect class;
saving the existing class and the aspect class into a source code data store;
receiving an activation request from the developer to activate the new feature;
removing the aspect class from the source code data store; and
transmitting the existing class to the developer for review.

13. (canceled)

14. The method of claim 12, further comprising:
altering the existing class with an aspect oriented scheme to extract one or more subroutines associated with the old feature for the insertion into the aspect class.

15. The method of claim 12, further comprising:
providing a feature filter attribute to the existing class to activate the new feature, wherein the feature filter attribute includes a feature name, a class name, and a subroutine name.

16. The method of claim 12, further comprising:
receiving a selection from the developer that relates the new feature to the old feature.

17. The method of claim 12, further comprising:
matching an attribute of the new feature to another attribute of the old feature; and
relating the new feature to the old feature based on the matched attribute.

18. A method executed on a computing device to automate a feature graduation, the method comprising:
receiving a request from a developer to implement a new feature of an application;
applying the new feature as a new subroutine into an existing class of the application by modifying the existing class with an aspect oriented scheme to insert the new subroutine into a joint location associated with an old feature, wherein the existing class includes the old feature related to the new feature;
extracting the old feature of the application from the existing class for an insertion into an aspect class;
saving the existing class and the aspect class into a source code data store;
receiving an activation request from the developer to activate the new feature;
removing the aspect class from the source code data store; and
transmitting the existing class to the developer for review.

19. The method of claim 18, further comprising:
altering the existing class with the aspect oriented scheme to extract one or more subroutines associated with the old feature for insertion into the aspect class.

20. The method of claim 18, further comprising:
detecting an activation of the new feature;
providing the existing class for an execution of the new feature at an implementation of the application; and
sending a return value that includes a product of the execution of the new feature.
